(19) United States
(12) Patent Application Publication
(10) Pub. No.: US 2006/0011759 A1
(43) Pub. Date: Jan. 19, 2006

(54) Garbage disposer with wireless control

(76) Inventor: Edward Chavez, Anaheim, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/181,464

(22) Filed: Jul. 14, 2005

Related U.S. Application Data
(60) Provisional application No. 60/588,517, filed on Jul. 16, 2004.

(51) Int. Cl. B02C 23/36

(52) U.S. Cl. 241/46.013

(57) ABSTRACT

A garbage disposer is provided with a wireless receiver switch, for operating the disposer from a wireless transmitter, without any additional wiring or interface between disposer and receiver. A disposer system includes disposer, receiver, and transmitter. A kit is also enclosed, which includes a disposer case extender, receiver, and transmitter.

### CROSS-REFERENCE TO RELATED APPLICATIONS

This application claims priority from U.S. Provisional Patent Application No. 60/588,517, filed on Jul. 16, 2004, entitled Garbage Disposer with Wireless Control, to inventor Edward Chavez, the contents of which are incorporated by reference herein in their entirety.

### FIELD OF THE INVENTION

1. Field

Embodiments relate to kitchen appliances, and in particular, to garbage disposers.

2. Related Art

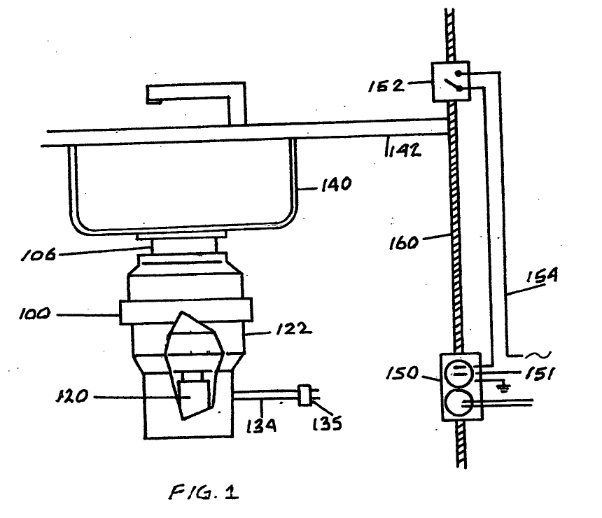

FIG. 1 is an illustration of a typical garbage disposer. Disposer 100 is driven by motor 120, housed in motor case 122. Disposer 100 is typically fastened under sink 140 and counter 142 by an interface mount 106. Motor 120 is powered through cable 134, ending in plug 135. Plug 135 is typically plugged into switched socket 150, which is controlled by switch 152. Socket 150 and switch 152 provide operating power for motor 120 at a current of approximately 5 Amps. A 15 or 20 Amp circuit breaker is typically used for a line powering a disposer. Wiring 151, 154, and 156 is typically located behind wall 160, out of sight.

A problem with typical disposer switched-outlet wiring is that if such wiring is not already in place, then re-wiring (and possibly wall repair) is required in order to provide switched power under counter top 142. Also, operators of disposers are typically performing dish-cleaning during disposer operation, and their hands are wet. Operating high-current wall switch 152 with wet hands may present the danger of electric shock.

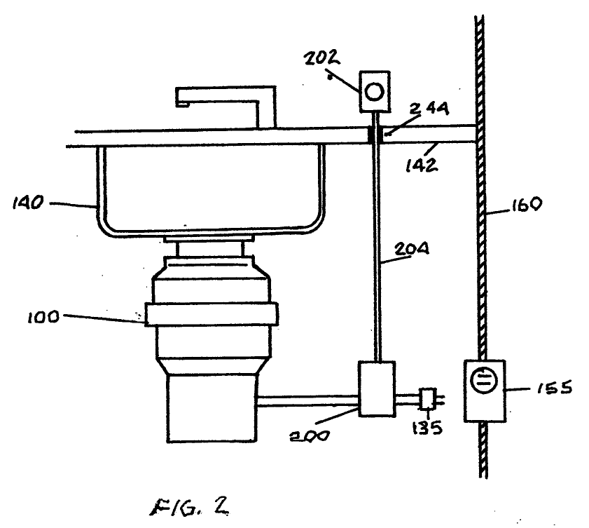

FIG. 2 is an illustration of a garbage disposer operated by a low voltage switch. Disposer 100 is connected through switch electronics 200 to plug 135, and thereby, power outlet 155 (not switched). Switch electronics 200 is controlled by control 202 through interface 204. Interface 204 is typically low power electronics, fiber optics, or pneumatic. Interface 204 has a path to control electronics 200, for example through hole 244 in counter top 142 (or sink 140).

A problem with low-power-interface controls is that a hole 244 is typically bored in counter top 142 in order to install the control. Other problems include the need to route low-power wires, tubes, or fibers around sink 140.

Therefore, what is required is a disposer than can be controlled remotely, eliminating electrical danger, which is also easily installed, without the need for re-wiring, construction, or damage to the counter top,

### SUMMARY

In order to provide a safe and convenient means of installing and operating a garbage disposer without altering sinks, countertops, or walls, or adding wiring or other connecting interfaces, a garbage disposer is provided with a radio control receiver operated by a wireless transmitter.

In some embodiments, the wireless garbage disposer has a receiver attached to the source and motor wiring. In some embodiments, the receiver is contained in the disposer case.

In some embodiments the receiver requires a digital code to be present in the signal. In some embodiments, the signal is a radio signal.

In some embodiments, the disposer is provided with a timer that switches the disposer off after a predetermined period of operation.

In some embodiments, a disposer system includes the disposer, receiver, and transmitter.

In some embodiments, a disposer remote operating kit includes a case extension, a receiver, and a transmitter.

### BRIEF DESCRIPTION OF THE ILLUSTRATIONS

FIG. 1 is an illustration of a typical garbage disposer of the prior art.

FIG. 2 is an illustration of a garbage disposer of the prior art, as operated by a low-voltage switch.

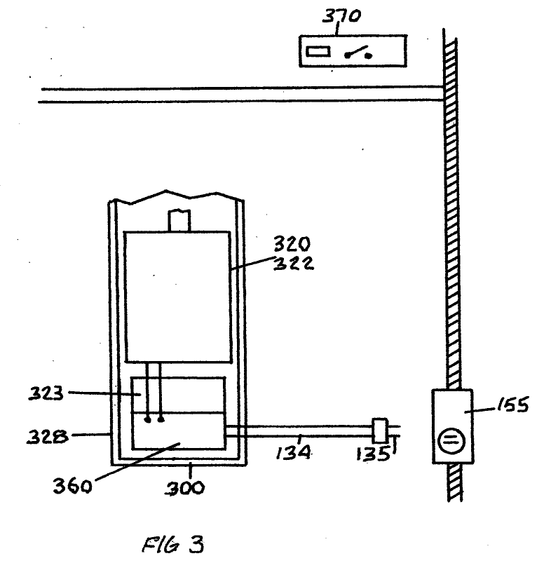

FIG. 3 is an illustration of an embodiment of a garbage disposer with a wireless remote control, according to the present invention.

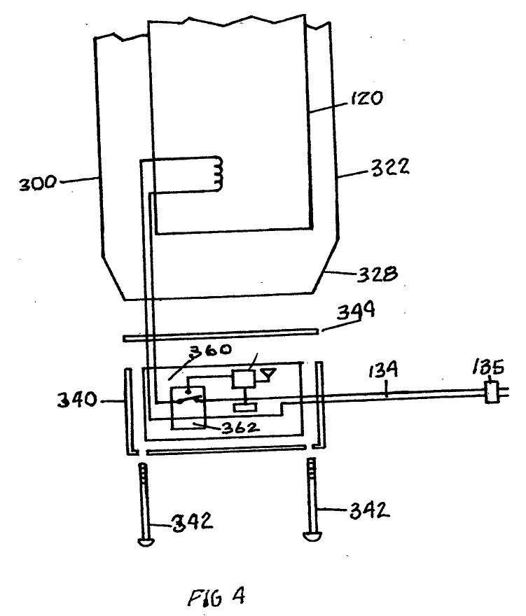

FIG. 4 is an illustration of an embodiment of a garbage disposer with a radio-frequency wireless control, according to the present invention.

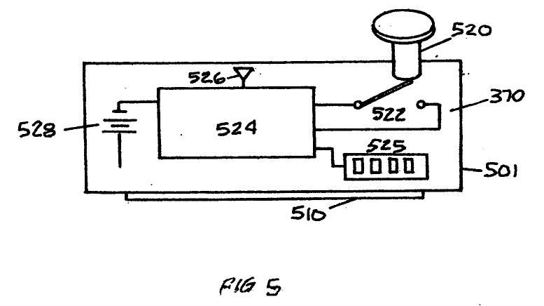

FIG. 5 is an illustration of an embodiment of a radio-frequency wireless control, according to the present invention.

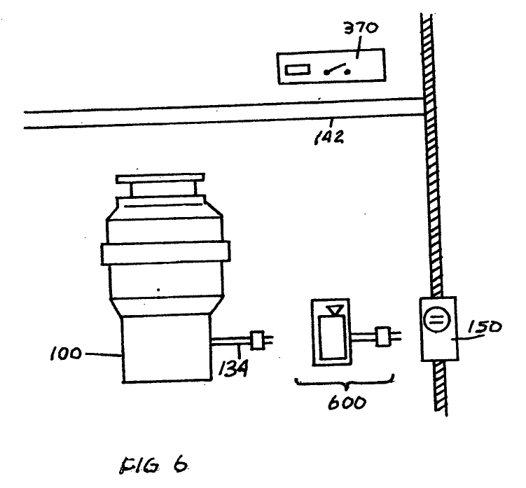

FIG. 6 is an illustration of a garbage disposer with an external wireless control.

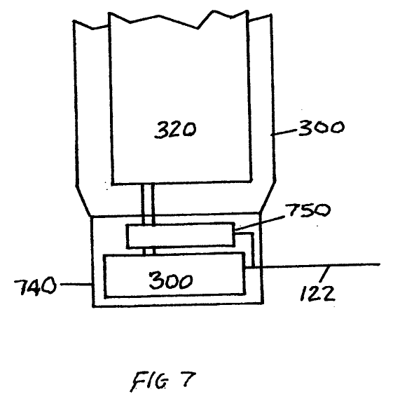

FIG. 7 is an illustration of a garbage disposer with a wireless control, having an electronic emission filter.

### DETAILED DESCRIPTION

FIG. 3 is an illustration of an embodiment of a garbage disposer with a wireless remote control, according to the present invention. In some embodiments, disposer 300 is shaped like typical disposer 100, having motor case 322 around motor 320, and ending in end-bell 323, encased in lower shell 328. Mount 306 attaches to sink 140 (referring to FIGS. 1 and 2). Embodiments include many types and models of disposer. For example, disposers can be fashioned to accommodate many different horse-power ratings (e.g., % HP, % HP, 1 HP), and different operating voltages (e.g., 110 VAG, 220 VAG).

In some embodiments, disposer 300 is provided with case extension 340, attaching to end-bell 323, and a longer lower shell 328, providing space for wireless control receiver switch 320. In some embodiments, extension 340 is added to typical disposer 100, below lower shell 328.

Wireless control receiver and switch unit 360 is connected by cable 134 and plug 135 to socket 155 (not switched). Cable 134 and plug 135 are made to the electrical design standard for the type of power to be supplied (e.g., hot, neutral, and ground for 110 VAC). Wireless control 370 transmits a signal to wireless control switch unit 360, in order to cause switch unit 360 to start or stop disposer 300. In some embodiments the signal is a radio frequency signal. In some embodiments other types of signals could be used (e.g., ultrasonic, millimeter waves).

Receiver switch unit 360 is rated at sufficient current and surge capacity to handle the conditions present in driving and switching disposer 300. In some embodiments, receiver switch unit 360 is rated to handle 1 kW of electric power. Wireless switches of this power range are produced by Baihuang Electric Co., 25 Ltd., of Cixi Ningbo, China.

In some embodiments, switch unit 360 of disposer 300 is provided with a safety timer, which turns off disposer 300 after a predetermined duration of operation. If disposer 300 is accidentally switched on or receives a spurious radio signal, operation is terminated after a reasonable time. In some embodiments, disposer 300 and/or switch unit 360 are also equipped with circuit breakers to prevent damage to motor 120, or potential danger from fire or electrocution if there is an over-current condition.

In some embodiments, receiver switch unit 360 operates on a digital coding system (e.g., as used in garage door openers), in order to prevent false commands from triggering the disposer to operate or stop. In some embodiments, different coded signals can be selected by settings on code switches 325.

FIG. 4 is an illustration of an embodiment of a garbage disposer with a radio-frequency wireless control, according to the present invention. In some embodiments, disposer motor 120 is attached to wireless switch unit 360 by drive wires 321. The action of switch 362 is controlled by control signal 363, generated by receiver 364. When antenna 366 receives an ON or OFF command radio signal, receiver 364 interprets the signal to send control signal 363 to switch 362 to switch power through lines 321 on or off, thus controlling the action of disposer 300.

In some embodiments, receiver switch unit 360 and transmitter 370 can be set to operate on one of a number of radio frequencies, in order to avoid interference with other transmitters and receivers.

In some embodiments, switch 362 receives power for its own operation over line 134. In some embodiments, control transmitter 370 is powered by one or more batteries (disposable or rechargeable) or by a transformer.

In some embodiments, extension 340 is attached to end-bell 323 by fasteners 342. In some embodiments, gasket 344 prevents leakage of water into extension 340.

FIG. 5 is an illustration of an embodiment of a radio-frequency wireless control, according to the present invention. Button 520 operates switch 522, which sends a signal to transmitter 524. Transmitter 524 sends an appropriate signal out antenna 526 when activated by switch 522. Transmitter 524 is powered by battery 528. Case 501 contains the components. In some embodiments, case 501 is provided with adhesive strip 510, which secures remote transmitter 370 to counter top 142, or other convenient surface.

In some embodiments, transmitter 370 sends a coded signal to receiver 360. In some embodiments the coded signal can be changed by code switches 525.

FIG. 6 is an illustration of a garbage disposer with an external wireless control unit that incorporates both a switch and a signal receiver. In some embodiments, wireless control receiver 600 is a separate unit from disposer 100 (an ordinary disposer). In some embodiments, wireless control receiver 600 is equivalent to or identical to model BH8836, produced by Baihuang Electric Co., Ltd., of Cixi Ningbo, China. Wireless control receiver 600 is capable of switching and controlling at least 1 kW of electric power.

FIG. 7 is an illustration of a garbage disposer with a wireless control, having an electronic emission filter. In some embodiments, particularly in the European Union, devices such as disposers are required by law to have electromagnetic emission control devices. Disposer 300 is provided with extended case 740 to fit both receiver 360 and filter 750. In addition to receiver/switch 360, electronic emission filter 750 is wired to motor 320.

In some embodiments, a remote control kit is provided to consumers, or manufacturers, or used for factory retrofitting. In some embodiments, a kit provides transmitter 370, switch 360, and extension 340. In some embodiments, a kit provides a longer version of lower shell 328. In some embodiments, a remote control kit includes hardware such as bolts 342 or gasket 344. Such kits may also include other useful materials, such as wire, electrical connectors, and instructions.

Thus a garbage disposer may be operated without any holes having to be drilled in countertop, sink, or walls. Further, operators are isolated from high power connections that may be dangerous under the wet conditions around a sink, or wet hands.

While various embodiments of the invention have been described, it should be understood that they have been presented by way of example and not limitation. Those skilled in the art will understand that various changes in forms or details may be made without departing from the spirit of the invention. Thus, the above description does not limit the breadth and scope of the invention as set forth in the following claims.

I claim:

1. A wireless garbage disposer, comprising:
a disposer unit, comprising a motor, comprising wiring capable of receiving electric power and directing electric power to the motor; and
a wireless remotely controlled receiver and switch component, capable of switching and directing a source of electrical power in response to a remote control signal;
wherein the wireless remotely controlled switch is connected to the wiring of the motor, so as to direct electric power to the motor, in response to the remote control signal.

2. The wireless garbage disposer of claim 1, wherein the disposer unit further comprises a case, and the remotely controlled switch component is secured in a portion of the case.

3. The wireless garbage disposer of claim 2, wherein the case comprises a disposer case and an extension portion, and the remotely controlled switch component is secured within the extension portion.

4. The wireless garbage disposer of claim 1, wherein the remote control signal is a radio-frequency signal.

5. The wireless garbage disposer of claim 1, wherein the remotely controlled switch component is capable of switching electric power on and off in response to a digital code in the remote control signal.

6. The wireless garbage disposer of claim 5, wherein the remotely controlled switch component comprises means for changing the digital code.

7. The wireless garbage disposer of claim 1, wherein the remotely controlled switch component further comprises a timer, the timer being capable of switching electric power off after a pre-determined time.

8. The wireless garbage disposer of claim 1, wherein the remotely controlled switch component is capable of switching and controlling at least 1 kW of electric power.

9. The wireless garbage disposer of claim 1, wherein the remote control signal is generated by a wireless control transmitter.

10. A wireless garbage disposer system, comprising:
a disposer unit, comprising a case and a motor;
a wireless remotely controlled receiver and switch component; wherein the switch component is capable of being connected to the motor, further capable of transmitting electricity from a source of electric power of up to at least 1 kilowatt, and further capable of switching the motor on and off in response to a received wireless signal; and
a wireless control transmitter, capable of providing the wireless signal to the receiver to switch the motor on or off.

11. The disposer system of claim 10, further comprising an electronic emission filter connected to said disposer.

12. The disposer system of claim 10, wherein the switch is retained inside a portion of the case.

13. The disposer system of claim 10, wherein the switch is capable of decoding a digital code contained in the received signal, and wherein the transmitter is capable of encoding the digital code in the signal.

14. The disposer system of claim 10, wherein the switch and transmitter comprise means for changing the digital code.

15. The disposer system of claim 10, wherein the switch further comprises a timer, capable of switching the motor off, after a pre-designated time of continuous operation.

16. The disposer system of claim 10, wherein the transmitter comprises means for being attached to a counter top.

17. The disposer system of claim 10, wherein the wireless switch component is located externally to the disposer unit, and is removably connected thereto.

18. A method of controlling the garbage disposer of claim 17, comprising:
providing a disposer, having a motor, with a wireless receiver, capable of switching the motor on or off in response to a received radio-frequency signal; and
providing a radio-frequency transmitter, capable of commanding the receiver to switch the motor on or off.

19. A remote control kit for a disposer, comprising:
a receiver-switch, having an interface, capable of being attached to the disposer motor and power supply wires, further capable of switching the motor on and off in response to a remote signal, further capable of transmitting electricity from a source of electric power of up to at least 1 kilowatt;
a case extender, capable of being attached to the case of a garbage disposer, further capable of enclosing the receiver; and
a transmitter, capable of providing the remote signal to the receiver.

20. The remote control kit of claim 19, wherein the switch further comprises a timer, capable of switching the motor off, after a pre-designated time of continuous operation; said switch further comprises means for decoding a digital code contained in the received signal; and said switch further comprises means for changing the digital code.
